(19) United States
(12) Patent Application Publication
(10) Pub. No.: US 2009/0269088 A1
(43) Pub. Date: Oct. 29, 2009

(54) REMAINING TONER QUANTITY DETECTOR, PROCESS CARTRIDGE AND IMAGE FORMING APPARATUS

(75) Inventor: Katsunori Mizuta, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Shinagawa-ku (JP)

(21) Appl. No.: 12/427,285

(22) Filed: Apr. 21, 2009

(30) Foreign Application Priority Data
Apr. 25, 2008 (JP) 2008-115164

(51) Int. Cl. G03G 15/08

(52) U.S. Cl. 399/30

(57) ABSTRACT

A remaining toner quantity detector includes a detector to detect a projection formed on a toner bottle which is rotated, a counter configured to count the number of rotations of the toner bottle by the detector and integrate the count, and a discriminator configured to discriminate the toner quantity in the toner bottle on the basis of the integrated value by the counter.

### CROSS-REFERENCE TO RELATED APPLICATION

This application is based upon and claims the benefit of priority from the prior Japanese Patent Application No. 2008-115164, filed on Apr. 25, 2008; the entire contents of all of which are incorporated herein by reference.

### FIELD OF THE INVENTION

The present invention relates to a remaining toner quantity detector, a process cartridge, and an image forming apparatus.

### DESCRIPTION OF THE BACKGROUND

As disclosed in Japanese Patent Application Publication No. 2002-268359, a conventional remaining toner quantity detection means in a toner bottle integrates the toner feeding operation time by a toner feed signal and infers the remaining toner quantity in the toner bottle from the toner feeding operation time.

However, when inferring the remaining toner quantity using the aforementioned remaining toner quantity detection means, a problem arises when the change in the torque applied to the motor does not depend on the change in the remaining toner quantity. For example, in case of trouble when the motor cannot rotate due to any abnormality, the time is counted and a large error is caused in the inference of the remaining toner quantity.

### SUMMARY OF THE INVENTION

An object of the present invention is to provide a remaining toner quantity detector for detecting correctly the remaining toner quantity even if a problem arises in rotation of a toner bottle, a process cartridge, and an image forming apparatus.

In an aspect of the present invention, an remaining toner quantity detector is provided and the remaining toner quantity detector comprises a detector configured to detect a projection formed on a toner bottle which is rotated; a counter to count the number of rotations of the toner bottle by the detector and integrate the count; and a discriminator configured to discriminate a toner quantity in the toner bottle on the basis of the integrated value by the counter.

Furthermore, in an aspect of the present invention, a process cartridge is provided and the process cartridge comprises a photoconductor; a charger to charge a surface of the photoconductor; a developing device configured to adhere toner onto an electrostatic latent image formed by exposing partially the photoconductor charged by the charger, thereby forming a toner image; a toner bottle having a formed projection provided rotatably so as to feed toner to the developing device; a detector configured to detect the projection of the toner bottle which is rotated; a counter configured to count the number of rotations of the toner bottle by the detector and integrate the count; and a discriminator configured to discriminate a toner quantity in the toner bottle on the basis of the integrated value by the counter.

Further, in an aspect of the present invention, an image forming apparatus is provided and the image forming apparatus comprises a photoconductor; a charger to charge a surface of the photoconductor; an exposure device configured to form an electrostatic latent image by exposing the surface of the photoconductor charged by the charger; a developing device configured to adhere toner onto the electrostatic latent image, thereby forming a toner image; a toner bottle having a formed projection provided rotatably so as to feed toner to the developing device; a detector to detect the projection of the rotary toner bottle; a counter configured to count the number of rotations of the toner bottle by the detector and integrate the count; and a discriminator configured to discriminate a toner quantity in the toner bottle on the basis of the integrated value by the counter.

And, in an aspect of the present invention, a toner quantity detecting method is provided and the remaining toner quantity detecting method comprises: rotating a toner bottle containing a toner and having a projection formed on the toner bottle; detecting the projection of the toner bottle while the toner bottle is rotating; counting the number of rotations of the toner bottle by detecting the projection and integrating the count to obtain an integrated value; and discriminating a toner quantity in the toner bottle on the basis of the integrated value.

Furthermore, in an aspect of the present invention, the image forming apparatus is provided and the image forming apparatus comprises a toner bottle having a projection, in which on an inner peripheral surface of the toner bottle, a spiral projecting portion is formed, and when the toner bottle rotates, by a movement of the spiral projecting portion, the toner in the toner bottle is conveyed from one side to the other side, and an opening is formed so that when the toner is conveyed from one side to the other side, the toner is discharged externally; a rotation structure configured to rotate the toner bottle in the first direction and in the opposite second direction; a detector to detect the projection; and a controller configured to control the rotation structure, wherein the controller rotates the toner bottle in the first direction via the rotation structure, detects the projection of the toner bottle and counts the number of rotations, discriminates a toner quantity in the toner bottle on the basis of the count, rotates the toner bottle in the second direction via the rotation structure, and discriminates the classification of the toner bottle on the basis of the time interval of detection of the projection by the detector.

And, in an aspect of the present invention, a toner bottle supported by a rotation structure of an image forming apparatus and detected for a rotation by a detector is provided and the toner bottle comprises a spiral projecting portion formed on an inner peripheral surface so as to convey stored toner from one side to the other side by rotation; an opening formed so as to discharge externally the toner when the toner is conveyed from one side to the other side; and a single projection provided in the neighborhood of the opening and is detected by the detector, wherein by detecting the single projection by the detector, a classification of the toner bottle and a toner quantity in the toner bottle are detected.

### BRIEF DESCRIPTION OF THE DRAWINGS

FIG. 1 is an internal schematic view showing the main body which is an embodiment of the present invention;

FIG. 2 is a cross sectional view of the process cartridge;

FIG. 3 is a block diagram of the control circuit of the remaining toner quantity detector which is an embodiment of the present invention;

FIGS. 4A to 4C are drawings for explaining that toner is fed by rotation of the toner bottle which is an embodiment of the present invention;

FIGS. 5A to 5C are drawings for explaining that the switch is pressed by the projection formed on the toner bottle which is an embodiment of the present invention;

FIG. 6A is a drawing showing the relationship of the remaining toner quantity in the toner bottle when the remaining toner quantity detector of the present invention is used, FIG. 6B is a drawing showing the relationship of the remaining toner quantity in the toner bottle when a conventional remaining toner quantity detector is used;

FIG. 7 is an illustration showing the relationship between the toner bottle and the projecting portion;

FIG. 8 is a waveform diagram showing the output when the switch detects the projection of the toner bottle; and

FIG. 9 is a flow chart showing the toner bottle discrimination method and the operation procedure of the apparatus.

### DETAILED DESCRIPTION OF THE INVENTION

Hereinafter, the embodiment of the present invention will be explained with reference to the accompanying drawings. However, the dimensions, materials, and shapes of the components described in the embodiment, unless otherwise specified, do not limit the scope of the present invention.

### Embodiment 1

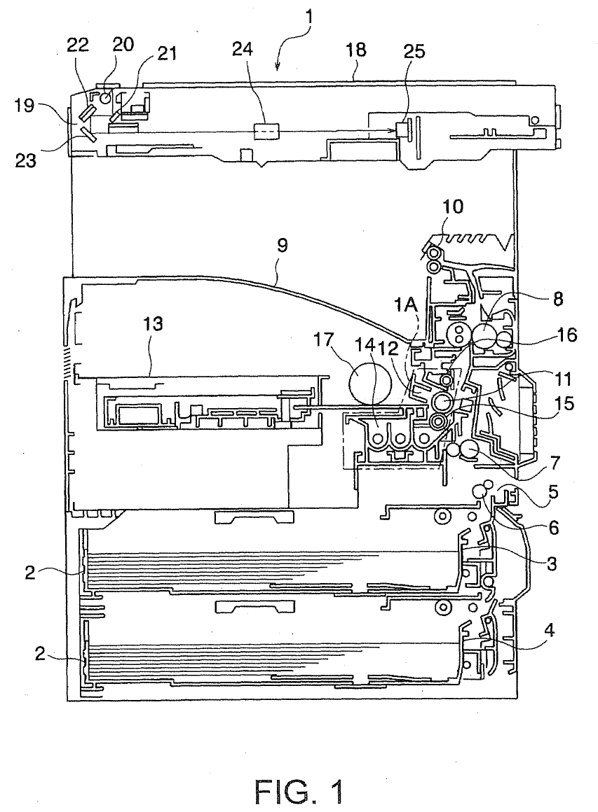

FIG. 1 is an internal schematic view showing the main body which is an embodiment of the present invention. Under an image forming apparatus 1, sheet supply cassettes 3 and 4 at a plurality of stages for storing recording materials 2 are provided. The recording materials 2 are conveyed upward via a conveying system 5. In the conveying system 5, conveying rollers 6 for conveying the recording materials 2 up to a process cartridge 1A, aligning rollers 7, a fixing device 8, and discharge rollers 10 for discharging the recording materials 2 after image recording to a receiving tray 9 are arranged.

At the central part inside the main body 1, the process cartridge 1A is provided removably on the main body 1. The process cartridge 1A has a photosensitive drum 11 attached rotatably. Around the photosensitive drum 11, in the direction of the arrow (counterclockwise), a corona discharge charger 12, an exposure device 13, a developing device 14, a transfer device 15, and a cleaning device 16 are arranged. Above the developing device 14, a toner bottle 17 is provided removably on the main body 1.

In the upper region of the main body 1, a document table 18 is provided. Under the document table 18, a scanner 19 for reading a document on the document table 18 is provided. The scanner 19 includes a light source 20 for irradiating light to the document, a first reflection mirror 21 for reflecting light reflected from the document in a predetermined direction, second and third reflection mirrors 22 and 23 for reflecting sequentially the light reflected from the first reflection mirror 21, a focusing lens 24 for imaging the reflected light from the third reflection mirror 23 on the image forming surface of a light receiving element 25, and the light receiving element 25 for receiving the light imaged by the focusing lens 24.

The operations of the respective devices at the time of image formation will be explained below. Firstly, when reading the document put on the document table 18, light is irradiated to the document from the light source 20. The light is reflected from the document and is received by the light receiving element 25 via the first reflection mirror 21, second reflection mirror 22, and third reflection mirror 23, thus the document image is read. Here, the first reflection mirror 21, by a drive means not drawn, moves in the longitudinal direction of the document from the underneath of the light source 20 shown in FIG. 1 and reads the document. At that time, to keep the optical path length which is a distance between the document and the image forming surface of the light receiving element 25 unchanged, the second reflection mirror 22 and third reflection mirror 23 move.

On the basis of the reading information, a laser beam is irradiated to the photosensitive drum 11 from the exposure device 13. The surface of the photosensitive drum 11 is charged uniformly by the charger 12, and the laser beam the intensity of which is modulated by the image information is irradiated from the exposure device 13, thus an electrostatic latent image equivalent to the image to be copied is formed on the photosensitive drum 11. The electrostatic latent image formed on the photosensitive drum 11 is adhered with toner which is charged at the reverse polarity to that of the electrostatic latent image by the developing device 14 and is changed to a visible image.

And, the toner adhered to the electrostatic latent image is conveyed from the underneath of the process cartridge 1A, is superimposed on the recording material 2 aligned by the aligning rollers 7, and by giving a charge at the reverse polarity to the charging polarity of the toner to the recording material 2 from the rear side of the recording material 2 by the transfer device 15, is transferred to the recording material 2 by the electrostatic force. The recording material 2 to which the toner is transferred is conveyed to the fixing device 8 and the toner is heated or pressurized by the fixing device 8, thereby is fixed. The recording material 2 after ending of the image formation is discharged to the receiving tray 9 via the discharge rollers 10. On the other hand, the residual toner remaining on the photosensitive drum 11 without transferred is removed by the cleaning device 16.

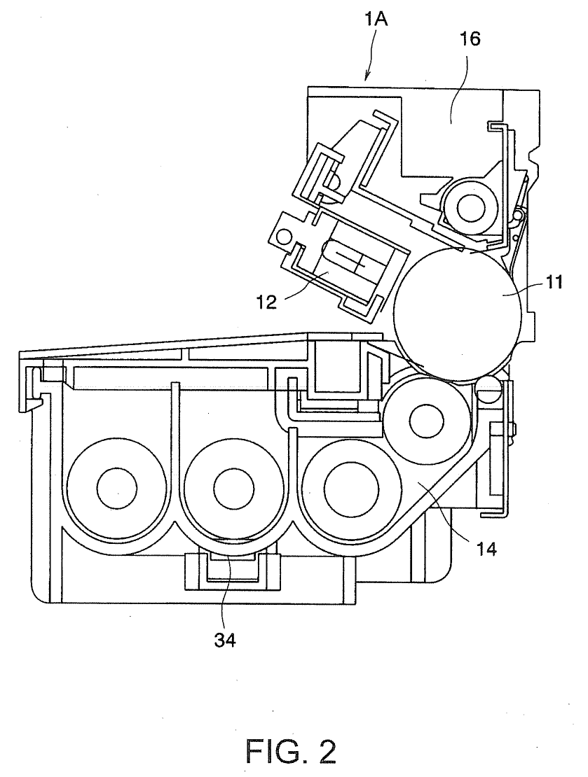

Next, the charger 12 in the process cartridge 1A will be explained. FIG. 2 is a cross sectional view of the process cartridge 1A. The process cartridge 1A is composed of the photosensitive drum 11, charger 12, developing device 14, and cleaning device 16. Further, the process cartridge 1A can be removed from the main body 1.

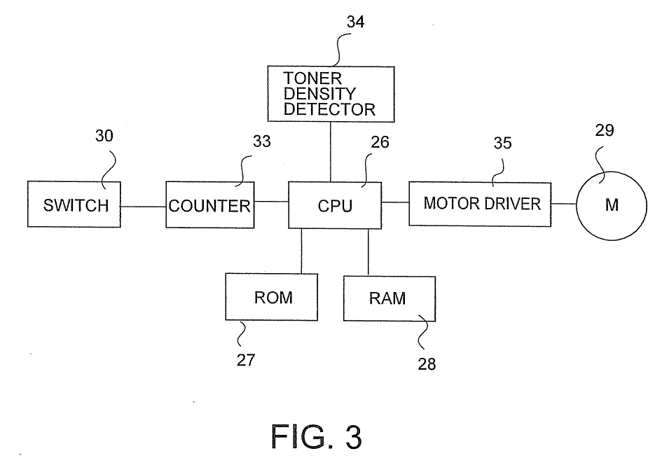

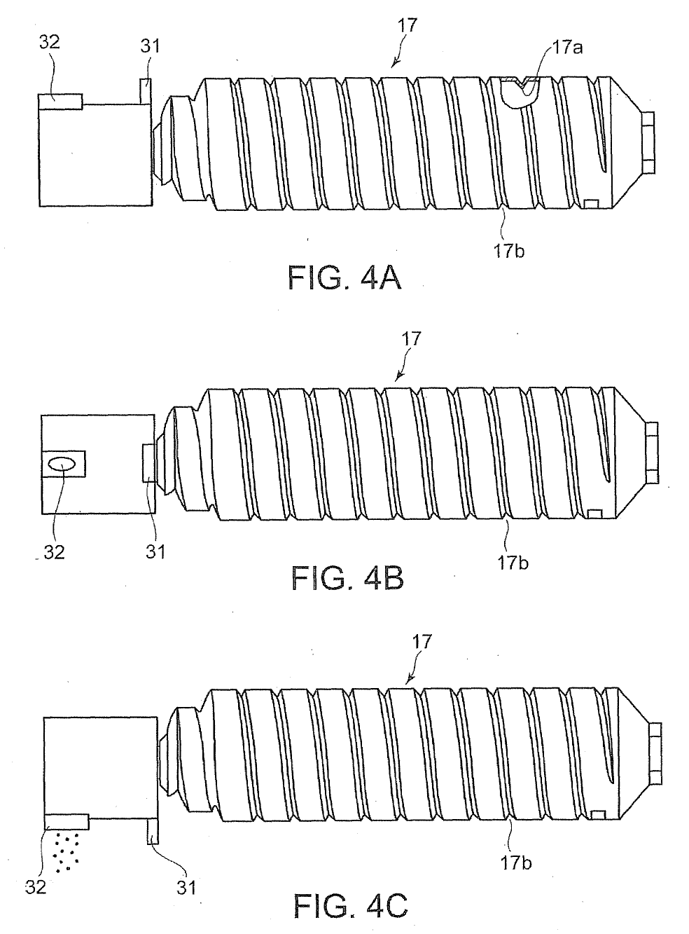

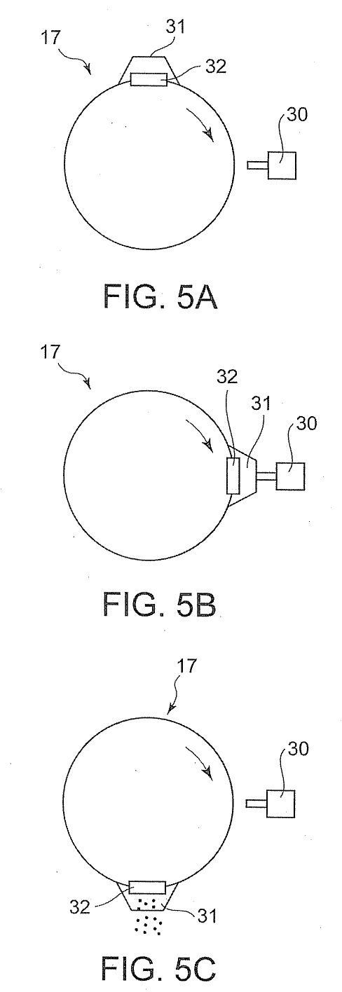

Next, the remaining toner quantity detector, toner bottle 17, and control circuit will be explained by referring to FIGS. 3 to 5. The toner bottle 17 is equipped with a projection 31 and an opening 32 for discharging toner. On the inner peripheral surface, a spiral projection 17a for conveying toner is formed spirally. If the toner bottle 17 rotates in a first direction, by the movement of the spiral projection 17a which is spirally formed on the inner peripheral surface of the toner bottle 17, the toner in the toner bottle 17 is conveyed toward the opening 32. Further, on the outer peripheral surface of the toner bottle 17 corresponding to the projection 17a, a spiral groove 17b is formed. The toner bottle 17 is connected to a motor 29 by a drive transfer mechanism not drawn such as a gear and upon receipt of the power of the motor 29 by the drive transfer mechanism, rotates sequentially as shown in FIGS. 5A, 5B, and 5C. As shown in FIGS. 4C and 5C, the toner bottle 17, when the opening 32 comes underneath by rotation, discharges toner from the opening 32, thereby feeds toner to the developing device 14.

In the neighborhood of the toner bottle 17, a switch 30 which is a detection means is provided. The switch 30 is provided at the position where, as shown in FIG. 5B, when the projection 31 comes to the position opposite to the switch 30 by the rotation of the toner bottle 17 in the direction of the arrow shown in the drawing, the projection 31 pressurizes the switch 30.

The main body 1, as shown in FIG. 3, includes a CPU 26 which is a discrimination means, a ROM 27 for storing the program of designating the operation procedure of the CPU 26, a RAM 28 for storing and reading data when necessary by the CPU 26, a counter 33 which is an integration means for counting and integrating the rotation of the toner bottle 17, the switch 30 for detecting the projection of the toner bottle 17 and outputting a detection signal to the CPU 26, and a motor driver 35 for driving the motor 29 for rotating the toner bottle 17.

If the reduction of toner in the developing device 14 is confirmed by a detection signal of a toner density detector 34 of the developer 14, the toner bottle 17 rotates and toner drops from the opening 32 and is fed into the developing device 14. If the toner bottle 17 rotates, the projection 31 formed on the toner bottle 17 pressurizes the switch 30. The switch 30 is pressed, thus the number of rotations of the toner bottle 17 is counted by the counter 33. Whenever the toner bottle 17 rotates, the number of rotations is counted and integrated. If the CPU 26 discriminates the toner quantity from the integrated data, the remaining toner quantity in the toner bottle 17 can be confirmed.

If the number of rotations of the toner bottle 17 is counted and integrated like this, the remaining toner quantity in the toner bottle 17 can be confirmed correctly.

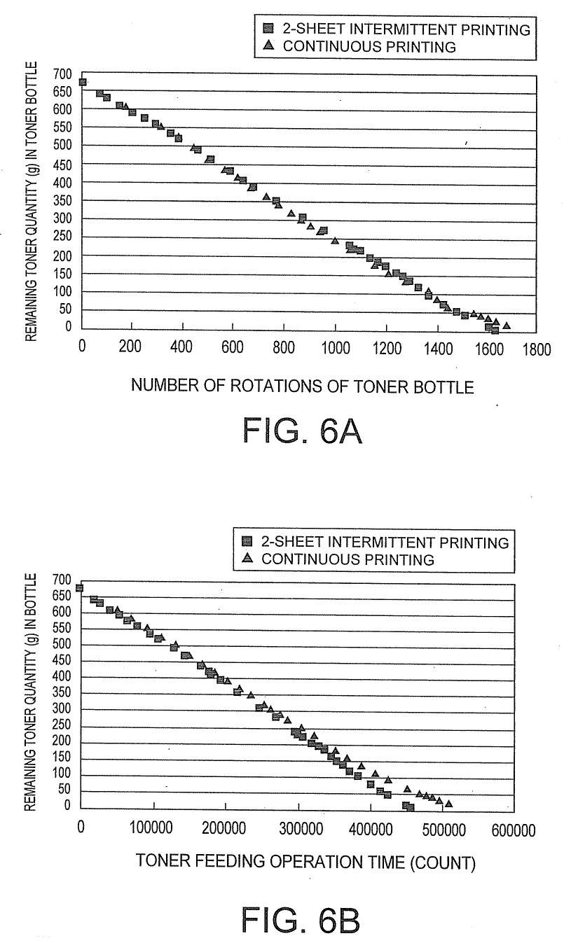

Here, in the remaining toner quantity detector of this embodiment, a drawing showing the remaining toner quantity in the toner bottle 17 to the number of rotations of the toner bottle 17 is shown in FIG. 6A. Further, for comparison with the remaining toner quantity of this embodiment, a drawing showing the remaining toner quantity in the toner bottle to the toner feeding operation time when a conventional discrimination means for the remaining toner quantity in the toner bottle is used is shown in FIG. 6B.

In FIGS. 6A and 6B, as printing conditions, the print size is A4, and the print rate is 6%, and the printing method includes two-sheet intermittent printing and continuous printing. Here, the two-sheet intermittent printing is a printing method for sending a two-sheet print job to print two sheets and when the two-sheet printing is finished, sending again the two-sheet print job. The continuous printing is a printing method for continuing printing ceaselessly.

When the remaining toner quantity detector of this embodiment is used, as shown in FIG. 6A, there are few errors caused between the two-sheet intermittent printing and the continuous printing and the remaining toner quantity can be detected accurately. On the other hand, in the conventional remaining toner quantity detection means shown in FIG. 6B, it can be confirmed that there are many errors caused between the two-sheet intermittent printing and the continuous printing.

The remaining toner quantity is not detected from the toner feeding operation time as the conventional remaining toner quantity detection means but the remaining toner quantity is detected from the number of rotations of the toner bottle 17 as this embodiment, thus even when a question arises in the operation of the toner bottle 17 such as a change in the torque of the toner bottle 17, the remaining toner quantity can be detected accurately.

In this embodiment, as shown in FIGS. 4A to 4C, the projection 31 is formed in the neighborhood of the opening 32 of the toner bottle 17 and the switch 30 is provided at the position where the projection 31 pressurizes the switch 30 when the projection 31 rotates. However, the installation position of the projection 31 may be an optional position if it is on the toner bottle 17. Further, the switch 30, in accordance with the installation position of the projection 31, may be provided at the position where it pressurizes the switch 30 when the projection 31 rotates.

Further, in this embodiment, to count the number of rotations of the toner bottle 17, a mechanical switch is used, though the present invention is not limited to it if any switch can count the number of rotations of the toner bottle 17.

In the remaining toner quantity of this embodiment, the projection 31 is provided. By use of the projection 31, whether the toner bottle 17 is a regular article or not can be detected. For example, in this embodiment, one projection 31 is used. However, two or three projections are provided, and the respective projections are arranged at optional positions on the toner bottle 17, thus if any projection is not provided at a predetermined position, it can be discriminated as an irregular article.

Next, the method for detecting the projection 31 formed on the toner bottle 17, thereby discriminating the classification of the toner bottle will be explained.

The CPU 26 outputs a control signal to the motor driver 35 according to the procedure, which will be described later, by referring to the flow chart and permits the motor driver 35 to drive the motor 29. The toner bottle 17 is rotated by the motor 29 and the switch 30 detecting the projection 31 gives a detection signal to the CPU 26. The CPU 26, on the basis of the detection signal, discriminates the toner bottle 17, or controls the number of rotations of the toner bottle 17 for the purpose of stirring the toner, or detects the remaining toner quantity.

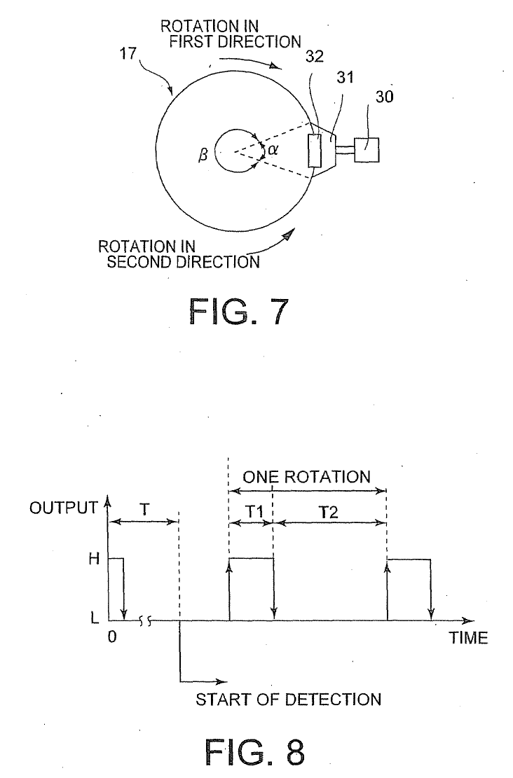

The position relationship between the switch 30 and the projection 31 of the toner bottle 17 is shown in FIG. 7. The switch 30 may be any one if it can detect the existence of the projection 31 and for example, an optical sensor or a mechanical limit switch may be used.

Further, it is possible to attach a magnetic material on the surface of the toner bottle 17 and detect it by a magnetic sensor. Or, it is also possible to attach an optically detectable mark such as a bar code on the surface of the toner bottle 17 and read it by an optical sensor. Namely, a constitution capable of discriminating the discriminated portion by a sensor is acceptable.

Here, the angle of existence of the projection 31 on the outer periphery of the toner bottle 17 is assumed as a and the angle of non-existence is assumed as B.

The CPU 26 controls the motor driver 35 so as rotate the toner bottle 17 in the second direction opposite to the first direction and rotates the motor 29. The rotation in the first direction is the rotation in the direction in which the toner in the toner bottle 17 moves to the opening 32. The rotation in the second direction is the rotation in the direction in which the toner moves to the reverse end part of the opening 32.

FIG. 8 shows the output waveform when the projection of the toner bottle 17 during rotation (regardless of the rotation in the first direction and the rotation in the second direction) is detected by the switch 30. During the period of time T1 when the switch 30 detects the projection 31, the output is on a high level and during the period of time T2 when the switch 30 does not detect the projection 31, the output is on a low level.

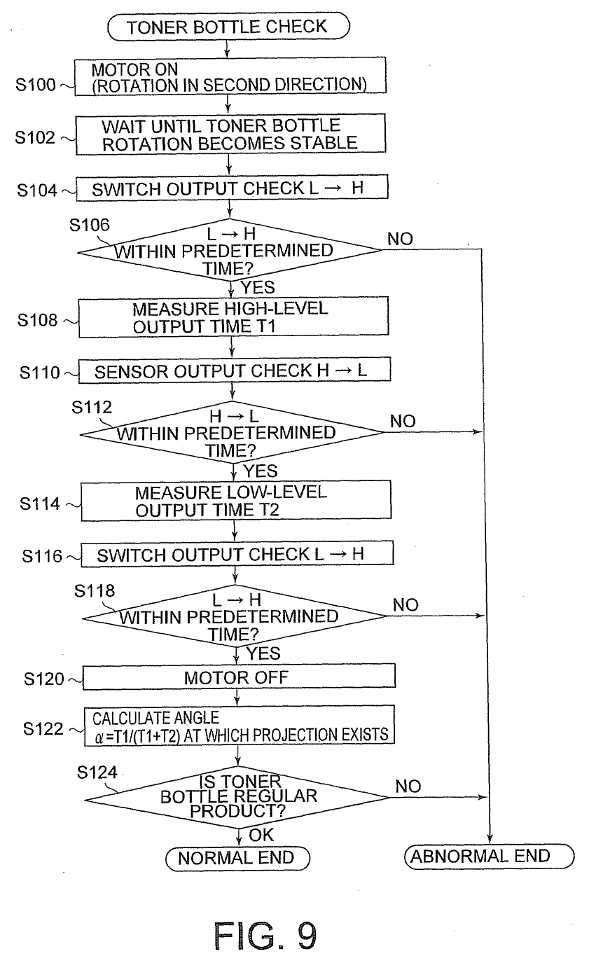

FIG. 9 shows the procedure of the discrimination process of the toner bottle 17 of this embodiment. At Step S100, the motor 29 starts rotation. The rotational direction is assumed as the second direction. The reason is that unlike the original operation of the toner bottle 17 such as supply of toner to the developing unit, whether the toner bottle 17 itself is a regular article or not is discriminated and the toner must be prevented from being discharged from the opening 32.

At Step S102, the CPU 26 stands by until the rotation of the toner bottle 17 is stabilized and during the period, does not check the output of the switch 30. The reason is that with the remaining toner quantity in the toner bottle 17, the time required for the motor 29 to reach the uniform velocity rotation is varied and the time of one rotation of the toner bottle 17 cannot be measured accurately. This is a more remarkable phenomenon occurring when a brush motor is used for the motor 29.

At Step S104, after stabilization of the rotation of the motor 29, the CPU 26 judges the output from the switch 30 and checks whether the output is changed from the low level to the high level or not.

At Step S106, when the output of the switch 30 is not changed from the low level to the high level for a predetermined period of time, that is, when the projection 31 does not exist at a predetermined position of the toner bottle 17, the CPU 26 judges that the toner bottle 17 is not a regular article and displays the purport of an error on the control panel. Inversely, when the output of the switch 30 is changed from the low level to the high level for the predetermined period of time, at Step S108, the CPU 26 starts measurement of the time T1 when the high level output is maintained.

At Step S110, the CPU 26 checks the output of the switch 30 and judges whether the output is changed from the high level to the low level or not. At Step S112, if the CPU 26 judges that the output is not changed from the high level to the low level for the predetermined period of time, it judges that the toner bottle 17 is not a regular article and displays the purport of an error on the control panel. When the output is changed from the high level to the low level for the predetermined period of time, at this point of time, the high-level output period of time T1 is decided.

Next, at Step S114, the CPU 26 starts measurement of the time T2 when the output is maintained on the low level. At Step S118, the CPU 26 judges whether the output is changed from the low level to the high level for the predetermined period of time or not and when it is not changed, displays the purport of an error on the control panel. When the output is changed from the low level to the high level for the predetermined period of time, at this point of time, the low-level output period of time T2 is decided.

At Step S120, according to the control of the CPU 26, the rotation of the motor 29 is stopped.

At Step S122, the CPU 26, using the high-level output period of time T1 and the low-level output period of time T2, calculates the angle α(=T1/(T1+T2)) of existence of the projection 31.

Here, in this embodiment, using the high-level output period of time T1 of the sensor and the low-level output period of time T2 thereof as a parameter, the CPU 26 detects the angle α of the projection 31 and uses it as a criterion. However, the present invention is not limited to it and for example, in a combination of the start-up timing and shut-down timing of an output signal of the switch 30, various criteria can be provided.

At Step S124, the CPU 26 judges whether the obtained angle α conforms to a regular article or not, and when it conforms to a regular article, judges that it is a regular article, and finishes the process. When it does not conform to a regular article, the CPU 26 displays the purport of an error on the control panel and finishes the process.

As mentioned above, according to this embodiment, it is possible to discriminate whether the toner bottle is a regular article or not using a simple method.

What is claimed is:

1. A remaining toner quantity detector, comprising:
a detector configured to detect a projection formed on a toner bottle which is rotated;
a counter to count the number of rotations of the toner bottle by the detector and integrate the count; and
a discriminator configured to discriminate a toner quantity in the toner bottle on the basis of the integrated value by the counter.

2. The remaining toner quantity detector according to claim 1, wherein the detector is a mechanical switch.

3. The remaining toner quantity detector according to claim 1, wherein on an inner peripheral surface of the toner bottle, a spiral projection is formed and if the toner bottle rotates, by a movement of the spiral projection, the toner in the toner bottle is conveyed from one side to the other side.

4. The remaining toner quantity detector according to claim 3, wherein in the toner bottle, when the toner is conveyed from one side to the other side, an opening is formed so as to discharge out the toner.

5. The remaining toner quantity detector according to claim 4, wherein the discriminator, when the toner is discharged from the opening, discriminates a toner quantity remaining in the toner bottle.

6. A process cartridge comprising:
a photoconductor;
a charger to charge a surface of the photoconductor;
a developing device configured to adhere toner onto an electrostatic latent image formed by exposing partially the photoconductor charged by the charger, thereby forming a toner image;
a toner bottle having a formed projection provided rotatably so as to feed toner to the developing device;
a detector configured to detect the projection of the toner bottle which is rotated;
a counter configured to count the number of rotations of the toner bottle by the detector and integrate the count; and
a discriminator configured to discriminate a toner quantity in the toner bottle on the basis of the integrated value by the counter.

7. The process cartridge according to claim 6, wherein the detector is a mechanical switch.

8. The process cartridge according to claim 6, wherein on an inner peripheral surface of the toner bottle, a spiral projection is formed and if the toner bottle rotates, by a movement of the spiral projection, the toner in the toner bottle is conveyed from one side to the other side.

9. The process cartridge according to claim 8, wherein in the toner bottle, when the toner is conveyed from one side to the other side, an opening is formed so as to discharge out the toner.

10. The process cartridge according to claim 9, wherein the discriminator, when the toner is discharged from the opening, discriminates a toner quantity remaining in the toner bottle.

11. An image forming apparatus comprising:
a photoconductor;
a charger to charge a surface of the photoconductor;
an exposure device configured to form an electrostatic latent image by exposing the surface of the photoconductor charged by the charger;
a developing device configured to adhere toner onto the electrostatic latent image, thereby forming a toner image;
a toner bottle having a formed projection provided rotatably so as to feed toner to the developing device;
a detector to detect the projection of the rotary toner bottle;
a counter configured to count the number of rotations of the toner bottle by the detector and integrate the count; and
a discriminator configured to discriminate a toner quantity in the toner bottle on the basis of the integrated value by the counter.

12. Then image forming apparatus according to claim 11, wherein the detector is a mechanical switch.

13. Then image forming apparatus according to claim 11, wherein on an inner peripheral surface of the toner bottle, a spiral projection is formed and if the toner bottle rotates, by a movement of the spiral projection, the toner in the toner bottle is conveyed from one side to the other side.

14. Then image forming apparatus according to claim 13, wherein in the toner bottle, when the toner is conveyed from one side to the other side, an opening is formed so as to discharge out the toner.

15. Then image forming apparatus according to claim 14, wherein the discriminator, when the toner is discharged from the opening, discriminates a toner quantity remaining in the toner bottle.

16. A remaining toner quantity detecting method, comprising:
rotating a toner bottle containing a toner and having a projection formed on the toner bottle;
detecting the projection of the toner bottle while the toner bottle is rotating;
counting the number of rotations of the toner bottle by detecting the projection and integrating the count to obtain an integrated value; and
discriminating a toner quantity in the toner bottle on the basis of the integrated value.

17. The method according to claim 16, wherein the detecting step is performed by using a mechanical switch.

18. The method according to claim 16, wherein on an inner peripheral surface of the toner bottle, a spiral projection is formed and if the toner bottle rotates, by a movement of the spiral projection, the toner in the toner bottle is conveyed from one side to the other side.

19. The method according to claim 18, wherein in the toner bottle, when the toner is conveyed from one side to the other side, an opening is formed so as to discharge out the toner.

20. The method according to claim 19, wherein the discriminating step discriminates a toner quantity remaining in the toner bottle when the toner is discharged from the opening.

21. An image forming apparatus comprising:
a toner bottle having a projection, in which on an inner peripheral surface of the toner bottle, a spiral projecting portion is formed, and when the toner bottle rotates, by a movement of the spiral projecting portion, the toner in the toner bottle is conveyed from one side to the other side, and an opening is formed so that when the toner is conveyed from one side to the other side, the toner is discharged externally;
a rotation structure configured to rotate the toner bottle in the first direction and in the opposite second direction;
a detector to detect the projection; and
a controller configured to control the rotation structure,
wherein the controller rotates the toner bottle in the first direction via the rotation structure, detects the projection of the toner bottle and counts the number of rotations, discriminates a toner quantity in the toner bottle on the basis of the count, rotates the toner bottle in the second direction via the rotation structure, and discriminates the classification of the toner bottle on the basis of the time interval of detection of the projection by the detector.

22. A toner bottle supported by a rotation structure of an image forming apparatus and detected for a rotation by a detector comprising:
a spiral projecting portion formed on an inner peripheral surface so as to convey stored toner from one side to the other side by rotation;
an opening formed so as to discharge externally the toner when the toner is conveyed from one side to the other side; and
a single projection provided in the neighborhood of the opening and is detected by the detector,
wherein by detecting the single projection by the detector, a classification of the toner bottle and a toner quantity in the toner bottle are detected.
